(19) United States
(12) Patent Application Publication
(10) Pub. No.: US 2005/0195700 A1
(43) Pub. Date: Sep. 8, 2005

(54) Disk detection system

(75) Inventors: Toru Iwatani, Tokyo (JP); Shinya Yamao, Tokyo (JP)

Correspondence Address: BIRCH STEWART KOLASCH & BIRCH, PO BOX 747, FALLS CHURCH, VA, 22040-0747, US

(73) Assignee: Mitsubishi Denki Kabushiki Kaisha

(21) Appl. No.: 11/031,065

(22) Filed: Jan. 10, 2005

(30) Foreign Application Priority Data
Mar. 5, 2004 (JP) 2004-62581

(51) Int. Cl. G11B 7/085

(52) U.S. Cl. 369/30.27

(57) ABSTRACT

A disk detection system includes a plurality of optical sensors disposed near a transport passage of a disk; a controller for carrying out exclusive driving of each one of the plurality of optical sensors sequentially at a predetermined period; and a detector for detecting an object on the transport passage according to a pattern of photodetector signals obtained from the plurality of optical sensors driven by the controller at every predetermined period. The configuration makes it possible to provide a disk detection system capable of preventing the interference between the plurality of optical sensors, and reducing the size and cost of the disk detection system.

### BACKGROUND OF THE INVENTION

1. Field of the Invention

The present invention relates to a disk detection system for detecting the presence or absence of an inserted disk, and particularly to a technique for preventing error detection.

2. Description of Related Art

Conventionally, a disk drive is known which loads a disk such as a CD (Compact Disc) and DVD (Digital Versatile Disk) inserted from a loading aperture, and plays it back. Such a disk drive usually includes a disk detection system for detecting the presence or absence of the disk insertion and the completion of the loading, and starts the playback when the disk detection system detects that the disk is loaded in the right position.

It is not unlikely, however, that a foreign object other than a disk such as a credit card and a parking card can be inserted into the loading aperture of the disk drive out of mischief of a child or the like. In such a case, the foreign object inserted can sometimes be loaded into the disk drive, making it difficult to pull it out, or bringing about a failure of the pickup or motor.

In view of this, a disk loading system has been developed which checks as to whether the object inserted from the loading aperture is a foreign object or not, and stops the loading and ejects the foreign object if some foreign object is inserted (see Relevant Document 1, for example). The disk loading system has a plurality of transmission optical sensors near a transport passage for conveying a disk. Each of the plurality of optical sensors includes a light-emitting device and a photo-detector disposed face to face on both sides of the transport passage to detect as to whether the path of light from the light-emitting device to the photo-detector is interrupted by an object conveyed through the transport passage. Then, according to the detection result, the disk loading system makes a decision as to whether the object inserted into the loading aperture is a disk or a foreign object to eject the foreign object and accept the disk to be loaded.

As another technique, a disk detection system is known which has a plurality of transmission optical sensors, each of which includes a light-emitting device and a photo-detector disposed on one side of the transport passage, and a long prism disposed on the other side of the transport passage. Each of the plurality of optical sensors detects as to whether the path of light emitted from the light-emitting device at a predetermined period and received by the photo-detector via the prism is interrupted by an object carried through the transport passage. Then, according to the detection result, the disk detection system carries out the same operation as the foregoing disk loading system.

Relevant Document 1: Japanese patent application examined publication No. 6-103568.

The foregoing conventional disk loading system and disk detection system have the plurality of light-emitting devices of the optical sensors driven simultaneously. Accordingly, the light emitted from a certain light-emitting device can leak, interfere or reflect off an object conveyed through the transport passage, thereby bringing about a state in which the light is received not only by the photo-detector coupled with that light-emitting device, but also by photo-detectors coupled with other light-emitting devices. As a result, an error decision has been made that the disk is inserted although it is not inserted, or that it is not inserted although it is actually inserted. Such error detection is increasing as the distances between the optical sensors become shorter because of the downsizing of the disk drive.

To circumvent such error detection, the interference between the plurality of optical sensors is prevented by providing a shielding plate (cover) to each optical sensor. However, when the disk drive has a complicated structure, the shielding plates impose dimensional restrictions, which offers a problem of being unable to achieve sufficient shielding. In addition, it has another problem of hindering the downsizing because of an increase in the shape of the disk drive by an amount of the shielding plates.

### SUMMARY OF THE INVENTION

The present invention is implemented to solve the foregoing problems. It is therefore an object of the present invention to provide a disk detection system capable of eliminating the interference between a plurality of optical sensors, and capable of reducing its size and cost.

To accomplish the foregoing object, according to an aspect of the present invention, there is provided a disk detection system including: a plurality of optical sensors disposed near a transport passage of a disk; a controller for carrying out exclusive driving of each one of the plurality of optical sensors sequentially at a predetermined period; and a detector for detecting an object on the transport passage according to a pattern of photodetector signals obtained by the plurality of optical sensors driven by the controller at every predetermined period.

The disk detection system in accordance with the present invention carries out exclusive driving of each one of the plurality of sensors sequentially. Accordingly, it can prevent the simultaneous light emission from the plurality of sensors. Thus, it can eliminate the interference between the plurality of optical sensors, which can obviate the need for the shielding plates required in the conventional system. As a result, the disk detection system can implement the reduction in its size and cost.

### BRIEF DESCRIPTION OF THE DRAWINGS

FIG. 1 is a block diagram showing a schematic electrical configuration of a disk drive to which a disk detection system of an embodiment 1 in accordance with the present invention is applied;

FIG. 2 is a circuit diagram showing a configuration of a first optical sensor in an optical sensor section as shown in FIG. 1;

FIG. 3 is a diagram showing placement of three optical sensors constituting the optical sensor section in a disk casing;

FIG. 4 is a table showing PS patterns provided by the optical sensors of the disk drive to which the disk detection system of the embodiment 1 in accordance with the present invention is applied;

FIG. 5 is a flowchart illustrating the operation of the disk drive to which the disk detection system of the embodiment 1 in accordance with the present invention is applied;

FIG. 6 is a flowchart illustrating the details of the PS pattern acquiring processing shown in FIG. 5;

FIG. 7 is a timing chart illustrating the operation of the PS pattern acquiring processing as shown in FIG. 5; and

FIG. 8 is a diagram showing an advantage of the disk drive to which the disk detection system of the embodiment 1 in accordance with the present invention is applied in comparison with a conventional disk detection system.

### DETAILED DESCRIPTION OF THE PREFERRED EMBODIMENT

The embodiment in accordance with the present invention will now be described with reference to the accompanying drawings.

### Embodiment 1

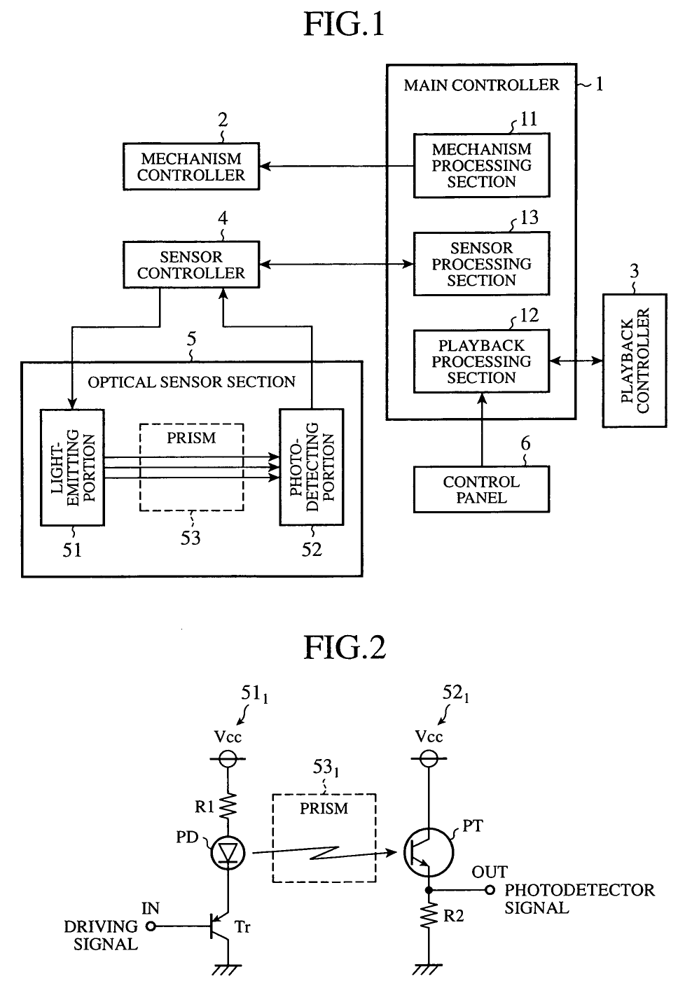

FIG. 1 is a block diagram showing a schematic electrical configuration of a disk drive to which a disk detection system of an embodiment 1 in accordance with the present invention is applied. The disk drive includes a main controller 1, a mechanism controller 2, a playback controller 3, a sensor controller 4, an optical sensor section 5 and a control panel 6. The control panel 6 has a plurality of switches (not shown) which are used for instructing selection of a tune recorded on a disk D, and instructing start, stop or pause of the playback of the tune selected.

The main controller 1 includes a microcomputer, for example, and controls the disk drive to which the disk detection system of the embodiment 1 in accordance with the present invention is applied. The main controller 1 includes a mechanism processing section 11, a playback processing section 12 and a sensor processing section 13, which are implemented by software processing of the microcomputer.

The mechanism processing section 11 instructs the mechanism controller 2 on the loading and ejection of the disk D, the rotation of the disk D and the movement of a pickup (head) The playback processing section 12 instructs the playback controller 3 to play back the information recorded on the disk D in response to the command from the control panel 6. The sensor processing section 13 instructs the sensor controller 4 to acquire information as to the state of the disk D. The processing carried out by the mechanism processing section 11, playback processing section 12 and sensor processing section 13 will be described in more detail later.

The mechanism controller 2 controls, in response to the instructions from the mechanism processing section 11, a loading motor for rotating a transport roller 72 (which will be described later), a spindle motor for rotating the disk D, and a thread motor for moving the pickup (head), which are not shown.

The playback controller 3 reads information recorded on the disk D in response to the instruction from the playback processing section 12, thereby playing back a sound signal. The sound signal played back by the playback controller 3 is supplied to the playback processing section 12.

The sensor controller 4 controls the optical sensor section 5. More specifically, the sensor controller 4 generates a driving signal in response to the instruction from the sensor processing section 13, and carries out pulse driving of the optical sensor section 5. In addition, the sensor controller 4 supplies the sensor processing section 13 with a photodetector signal fed from the optical sensor section 5 in response to the pulse driving as a detection signal. A controller, a detector and a processing section in accordance with the present invention are composed of the sensor controller 4 and the sensor processing section 13.

The optical sensor section 5, which corresponds to a plurality of optical sensors in accordance with the present invention, includes three optical sensors: a first optical sensor PS1; a second optical sensor PS2; and a third optical sensor PS3. Since all the optical sensors have the same configuration, only the first optical sensor PS1 will be described below. The first optical sensor PS1 includes a light-emitting portion 51₁, a photo-detecting portion 52, and a long prism 53₁. The prism 53₁, the details of which will be described later, is used for guiding the light emitted from the light-emitting portion 51₁ to the photo-detecting portion 52₁. Incidentally, FIG. 1 shows the components of the three optical sensors as the light-emitting portion 51, photo-detecting portion 52 and prism 53 with removing their suffixes.

FIG. 2 is a circuit diagram showing a configuration of the first optical sensor PS1. The light-emitting portion 51₁ has a resistor R1, a light-emitting diode PD and a PNP-type transistor Tr connected in series across a power supply Vcc and a ground. The resistor R1 has its first end connected to the power supply Vcc, and its second end to the anode of the light-emitting diode PD. The light-emitting diode PD has its cathode connected to the emitter of the transistor Tr. The transistor Tr has its collector grounded, and its base connected to an input terminal IN which is supplied with the driving signal from the sensor controller 4.

In the light-emitting portion 51₁ with the foregoing configuration, the transistor Tr is brought into conduction when the driving signal fed from the sensor controller 4 to the input terminal IN is placed at the low level (called “L level” from now on). Thus, a current flows from the power supply Vcc to the ground through the resistor R1, light-emitting diode PD and transistor Tr, and the light-emitting diode PD begins to emit light. In contrast, the transistor Tr is brought out of conduction when the driving signal fed from the sensor controller 4 to the input terminal IN is placed at a high level (called “H level” from now on). Thus, the current flowing from the power supply Vcc to the ground through the resistor R1, light-emitting diode PD and transistor Tr is interrupted, and the light-emitting diode PD stops emitting the light. The light emitted from the light-emitting diode PD is input to a first end of the prism 531 passes through its inside, and is output from its second end.

The photo-detecting portion 52₁ has a phototransistor PT and a resistor R2 connected in series across the power supply Vcc and the ground. The phototransistor PT has its collector connected to the power supply Vcc, and its emitter connected to a first end of the resistor R2. The resistor R2 has its second end grounded. The emitter of the phototransistor PT and the first end of the resistor R2 are connected to the output terminal OUT. The light-receiving face of the phototransistor PT (which corresponds to the base) is irradiated with the light transmitted from the light-emitting portion 51₁ via the prism 53₁.

In the photo-detecting portion 52₁ with the foregoing configuration, the phototransistor PT has its light-receiving face irradiated with the light transmitted from the light-emitting portion 51₁ via the prism 53₁, thereby being brought into conduction. Thus, a current flows from the power supply Vcc to the ground through the phototransistor PT and resistor R2, and a photodetector signal with the high level is produced from the output terminal OUT. On the other hand, the phototransistor PT is brought out of conduction when the irradiation of the light-receiving face is removed. Thus, the current flowing from the power supply Vcc to the ground through the phototransistor PT and resistor R2 is interrupted, and the photodetector signal with the low level (ground level) is output from the output terminal OUT. The photodetector signal output from the output terminal OUT is delivered to the sensor controller 4.

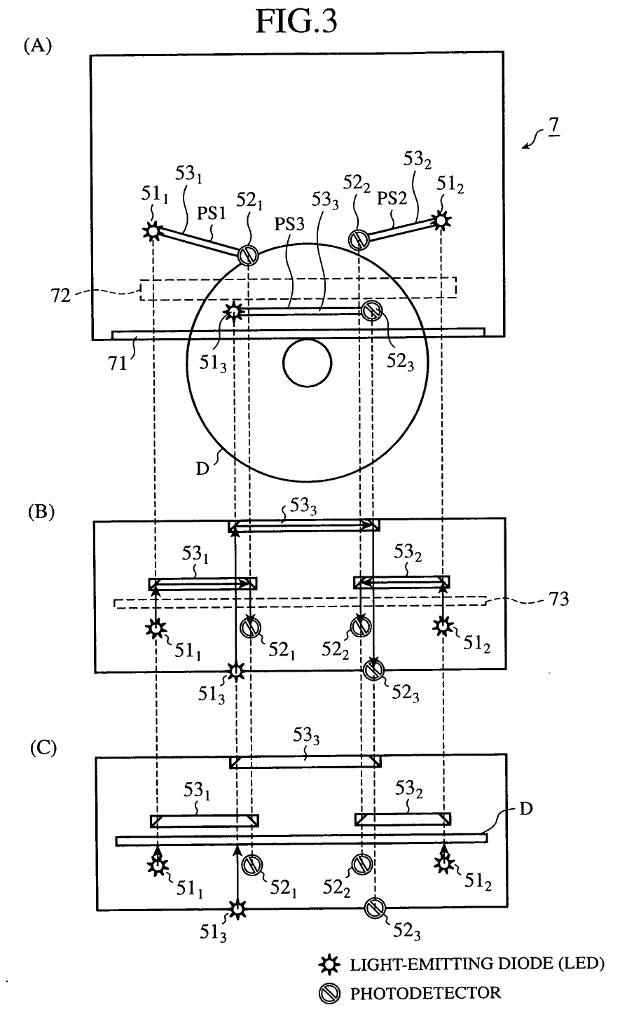

Next, the arrangement of the three optical sensors constituting the optical sensor section 5 in the disk casing will be described with reference to FIG. 3.

FIG. 3(A) is a schematic plan view showing an arrangement of the first optical sensor PS1, second optical sensor PS2 and third optical sensor PS3 in a disk casing 7; and FIG. 3(B) is a front view thereof. The disk D, which is inserted into a loading aperture 71 in the front of the disk casing 7, is carried through a transport passage 73 by the transport roller 72, and is taken into the disk casing 7. Thus, the disk D is set on a turntable (not shown) disposed in a predetermined position in the disk casing 7.

The first optical sensor PS1 is installed at the left rear in the disk casing 7, the second optical sensor SP2 is placed at the right rear in the disk casing 7, and the third optical sensor SP3 is installed at the immediate back of the loading aperture 71 in the front of the disk casing 7.

The first optical sensor PS1 includes the light-emitting portion 51₁ and the photo-detecting portion 52₁ disposed under the transport passage 73, and a prism 53₁ installed above the transport passage 73. The light produced by the light-emitting portion 51₁ is launched right above, passes through an upward optical path, and is input to a first end portion of the prism 53₁. Then, the light, the optical path of which is changed to the horizontal direction by the prism 53₁, is launched right under from a second end portion of the prism, and is input to the photo-detecting portion 52₁ via a downward optical path. As for the second optical sensor SP2 and third optical sensor SP3, a similar operation is carried out.

The upward path and downward path of each of the first optical sensor PS1, second optical sensor PS2 and third optical sensor PS3 are interrupted by the disk D or foreign object which is inserted into the loading aperture 71 and carried through the transport passage 73 as shown in FIG. 3(C). Which upward path and/or downward path of which optical sensor is interrupted varies depending on the transport position of the object. Accordingly, the type and position of the object on the transport passage 73 can be identified by 3-bit patterns (called “PS patterns” from now on) formed by assigning “1” and “0” to the presence or absence of the photodetector signal from the first optical sensor PS1, second optical sensor PS2 and third optical sensor PS3.

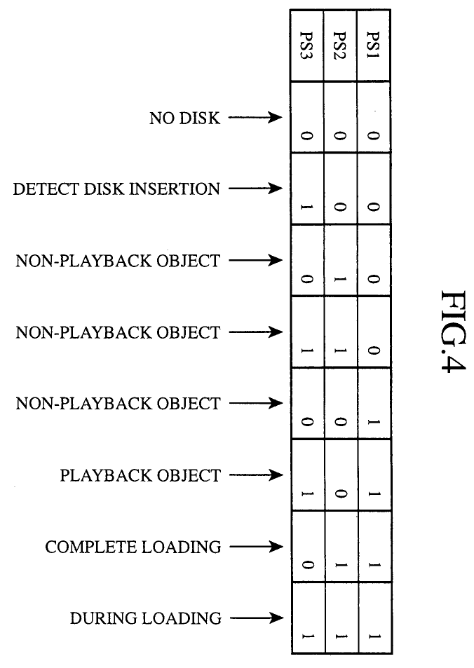

Assigning “1” to the case where the optical path of the optical sensor is interrupted by the object, and “0” to the case when it is not interrupted enables the PS patterns (PS1, SP2, PS3) to be expressed as shown in FIG. 4. Conversely, in this disk drive, the arrangement of the first optical sensor PS1, second optical sensor PS2 and third optical sensor PS3 is decided in such a manner that the PS patterns as shown in FIG. 4 are provided.

In FIG. 4, the PS pattern (000) indicates that none of the optical paths of the optical sensors are interrupted, which means “no disk”. The PS pattern (001) indicates that only the optical path of the third optical sensor PS3 is interrupted, which means that “disk insertion detection” is made. The PS pattern (111) indicates that the optical paths of all the optical sensors are interrupted, which means that the disk is “during loading”. The PS pattern (110) indicates that the optical paths of the first optical sensor PS1 and second optical sensor PS2 are interrupted, which means the “loading completion”. The PS pattern (101) indicates that the optical paths of the first optical sensor PS1 and third optical sensor PS3 are interrupted, which means “playback object”. The playback object refers to an 8 cm disk or 12 cm disk. The remaining PS patterns indicate “non-playback object”. The non-playback object refers to an object other than the 8 cm disk or 12 cm disk, that is, a foreign object. The main controller 1 carries out loading processing, ejection processing and playback processing according to the PS patterns.

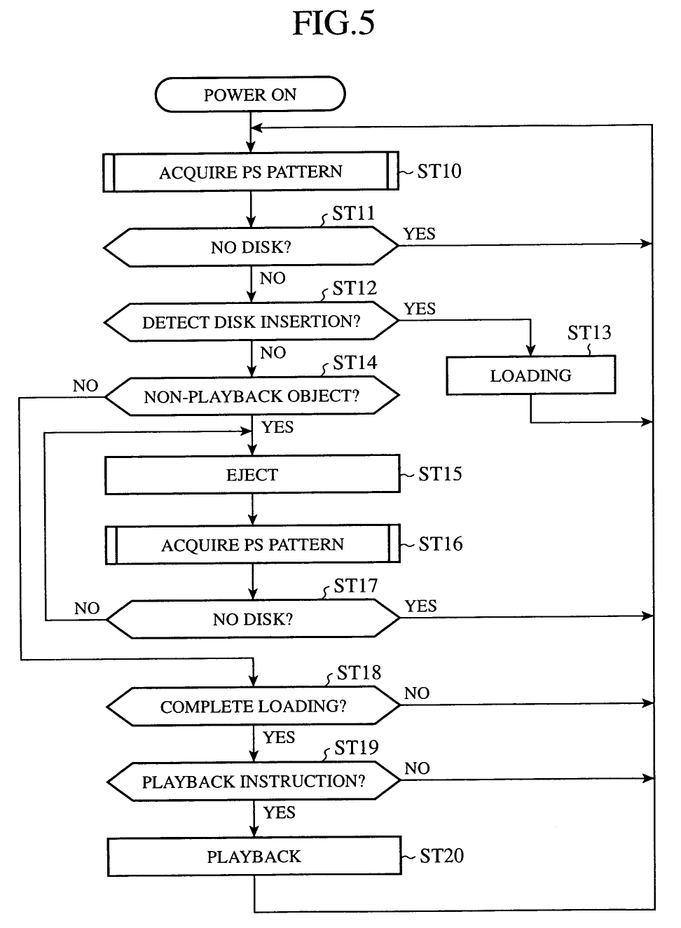

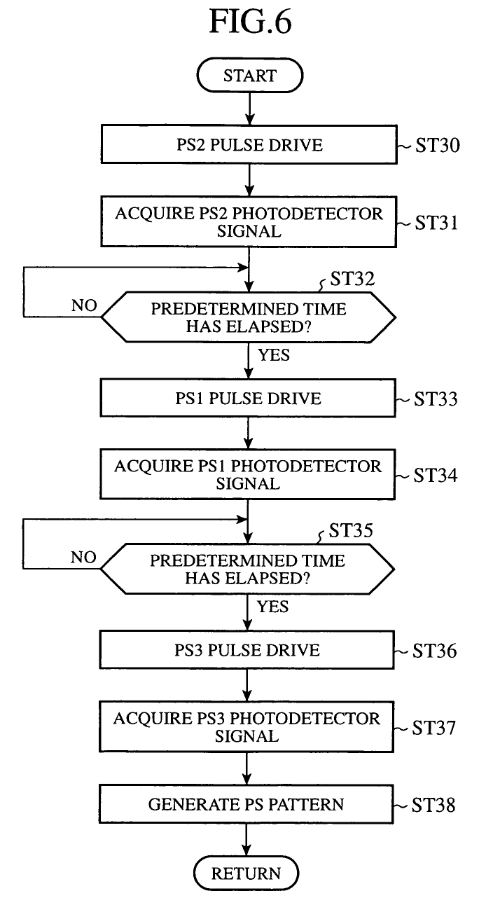

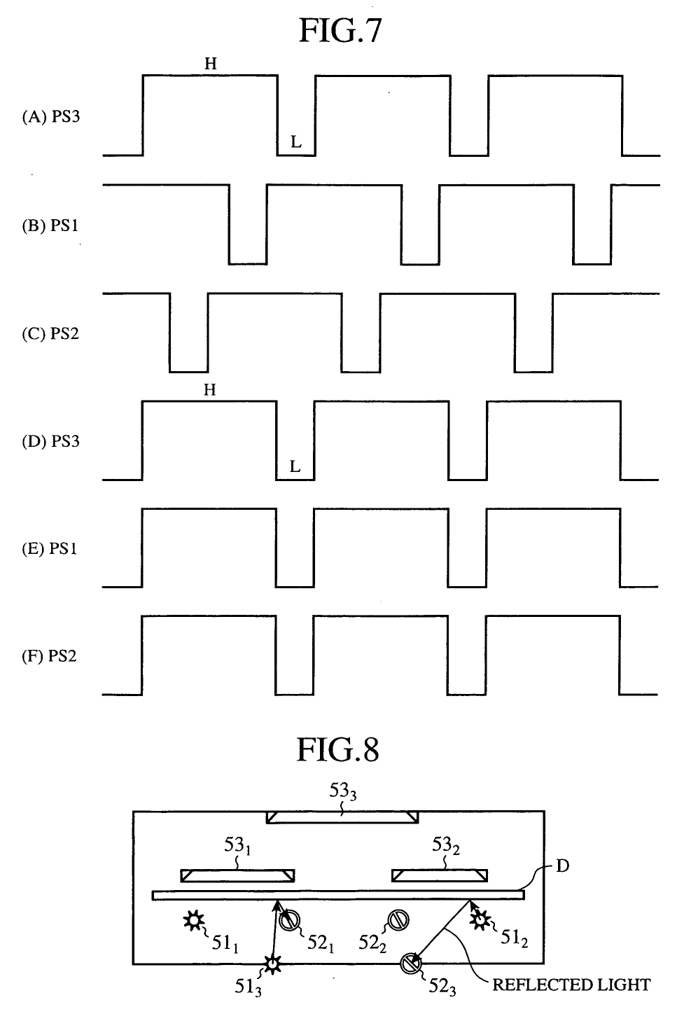

Next, the operation of the disk drive with the foregoing configuration, to which the disk detection system of the embodiment 1 in accordance with the present invention is applied, will be described with reference to the flowcharts illustrated in FIGS. 5 and 6, and the timing chart illustrated in FIG. 7.

When the power supply is turned on, the disk drive carries out the acquiring processing of the PS pattern (step ST10). More specifically, the sensor processing section 13 of the main controller 1 instructs the sensor controller 4 to acquire the PS pattern, and obtains the PS pattern as shown in FIG. 4 from the sensor controller 4. The details of the acquiring processing of the PS pattern will be described later.

Subsequently, a decision is made as to whether the PS pattern indicates “no disk” or not (step ST1). Specifically, the sensor processing section 13 checks whether the PS pattern obtained at step ST10 is (000), which indicates “no disk”. If a decision is made at step ST11 that the PS pattern indicates “no disk”, the sequence returns to step ST10 to repeat the foregoing processing. Thus, once the power supply is turned on, the disk drive, iterating steps ST10 and ST11, enters a standby mode in which it waits for the transition of the “no disk” to another state, that is, waits for the disk D to be inserted.

If a decision is made in the standby mode that the PS pattern is not “no disk” at step ST11, then a decision is made as to whether the insertion of the disk D is detected or not (step ST12). The sensor processing section 13 carries out that operation by checking whether the PS pattern obtained at step ST10 is (001), that is, indicates “disk insertion detection” or not.

If a decision is made at step ST12 that the insertion of the disk D is detected, then the loading processing is carried out (step ST13). More specifically, the sensor processing section 13 instructs the mechanism processing section 11 to start loading. In response to the instruction, the mechanism processing section 11 provides the mechanism controller 2 with the loading instruction. In response to it, the mechanism controller 2 drives a loading motor not shown to rotate the transport roller 72 in the forward direction, and to carry the object inserted (called “inserted object” from now on) via the loading aperture 71 into the disk casing 7. After that, the sequence returns to step ST10 to repeat the foregoing processing. The loading processing is continued until the decision result at step ST12 is not “disk insertion detection” anymore. The state immediately after the decision result is no longer “disk insertion detection” at step ST12, is a state in which the rear end of the inserted object is on the transport roller 72.

If a decision is made at step ST12 that it is no longer “disk insertion detection”, then the next decision is made as to whether the object is anon-playback object or not (step ST14) More specifically, the sensor processing section 13 checks whether the PS pattern obtained at step ST10 is (010), (011) or (100). If a decision is made at step ST14 that it is a non-playback object, the inserted object is identified as a foreign object, followed by the ejection processing (step ST15). Specifically, the sensor processing section 13 instructs the mechanism processing section 11 to start ejection. In response to the instruction, the mechanism processing section 11 sends an ejection instruction to the mechanism controller 2. Then, the mechanism controller 2 drives the loading motor not shown to rotate the transport roller 72 backward. Thus, the inserted object with its rear end placed on the transport roller 72 is transferred to the outside of the disk casing 7.

Subsequently, the acquiring processing of the PS pattern is carried out (step ST16) as in the foregoing step ST10, and a decision is made as to whether the PS pattern indicates “no disk” or not (step ST17). If a decision is made that the PS pattern does not indicate “no disk”, the sequence returns to step ST15 to continue the foregoing ejection processing. The ejection processing is continued until the decision result at step ST17 becomes “no disk”. Thus, if the inserted object is a foreign object, it is completely ejected from the loading aperture 71 of the disk casing 7 by the time when the decision result at step ST17 becomes “no disk”. After that, the sequence returns to step ST10, and enters the standby mode.

If a decision is made at step ST14 that the object is not the non-playback object, then a decision is made as to whether the PS pattern indicates “loading completion” or not (step ST18). Specifically, the sensor processing section 13 checks whether the PS pattern obtained at step ST10 is (110), that is, indicates “loading completion”. If a decision is made that it is not “loading completion”, the sequence returns to step ST10 to iterate the foregoing processing. Incidentally, when a decision is made at step ST18 that the PS pattern does not indicate “loading completion”, the pattern obtained at step ST10 indicates “playback object” (101) or “during loading” (111).

If a decision is made at step ST18 that the PS pattern indicates “loading completion”, the sensor processing section 13 notifies the playback processing section 12 that the loading has been completed. Subsequently, a decision is made as to whether a playback instruction is present or not (step ST19). Specifically, the playback processing section 12, which receives the notification that the loading has been completed from the sensor processing section 13, checks whether the playback instruction is input via the control panel 6. If a decision is made that the playback instruction is not input, the sequence returns to step ST10 to iterate the foregoing processing.

In contrast, if a decision is made at step ST19 that the playback instruction is input, the playback processing is carried out (step ST20). More specifically, the playback processing section 12 instructs the mechanism processing section 11 to rotate the disk D. In response to the instruction, the mechanism processing section 11 sends the disk rotation instruction to the mechanism controller 2. Thus, the mechanism controller 2 drives and rotates the spindle motor not shown.

After that, the playback processing section 12 instructs the mechanism processing section 11 to move the pickup to a position on a disk at which the tune data designated by the control panel 6 is recorded (called “target position” from now on). In response to the instruction, the mechanism processing section 11 sends to the mechanism controller 2 a movement instruction of the pickup including data specifying the target position. Thus, the mechanism controller 2 drives the thread motor not shown, and moves the pickup to the target position.

Furthermore, the playback processing section 12 sends to the playback controller 3 a playback instruction to reproduce the tune. In response to the playback instruction, the playback controller 3 reads the information recorded on the disk D, and plays back the sound signal. The sound signal reproduced by the playback controller 3 is supplied to the playback processing section 12. The playback processing section 12 performs prescribed processing on the sound signal, and supplies it to the amplifier not shown. In this way, the music recorded on the disk D is reproduced. After the foregoing playback processing has been completed, the sequence returns to step ST10 to iterate the foregoing processing.

Next, details of the acquiring processing of the PS pattern performed at step ST10 of the flowchart shown in FIG. 5 will be described with reference to the flowchart shown in FIG. 6 and to the timing chart shown in FIG. 7.

In the acquiring processing of the PS pattern, the second optical sensor PS2 is pulse driven, first (step ST30). More specifically, the sensor processing section 13 sends a driving instruction of the second optical sensor PS2 to the sensor controller 4. In response to the driving instruction, the sensor controller 4 generates a pulsed driving signal having an L level section of about 200 μs as illustrated in FIG. 7(C), and sends it to the light-emitting portion 51₂. Thus, the transistor Tr of the light-emitting portion 51₂ is brought into conduction, causing the current to flow through the light-emitting diode PD to emit light. The light produced by the light-emitting diode PD passes through the prism 53₂, and irradiates the light-receiving face of the phototransistor PT of the photo-detecting portion 52₂. Thus, the phototransistor PT is brought into conduction, and the output terminal OUT produces the H level photodetector signal, and sends it to the sensor controller 4. Receiving the signal from the photo-detecting portion 52, the sensor controller 4 sends it to the sensor processing section 13.

Subsequently, the photodetector signal by the second optical sensor PS2 is captured (step ST31). Specifically, the sensor processing section 13 acquires the photodetector signal from the sensor controller 4, and stores it in its internal memory. Subsequently, a decision is made as to whether a predetermined time period has elapsed or not (step ST32). Specifically, the sensor controller 13 has a timer not shown carry out counting, and waits for the predetermined time period to elapse with iterating the step ST32. As for the predetermined time period, it can be set at about 100 μs, for example.

If a decision is made at step ST32 that the predetermined time period has elapsed, the first optical sensor PS1 is pulse driven (step ST33). More specifically, the sensor processing section 13 sends the driving instruction of the first optical sensor PS1 to the sensor controller 4. In response to the driving instruction, the sensor controller 4 generates a pulsed driving signal with an L level section of about 200 μs as illustrated in FIG. 7(B), and sends it to the light-emitting portion 51₁. Thus, the transistor Tr of the light-emitting portion 51₁ is brought into conduction, which causes a current to flow through the light-emitting diode PD to emit light. The light produced by the light-emitting diode PD passes through the prism 53₁, and irradiates the light-receiving face of the phototransistor PT of the photo-detecting portion 52₁. Thus, the phototransistor PT is brought into conduction, and an H level photodetector signal is supplied from the output terminal OUT to the sensor controller 4. The sensor controller 4 transfers the signal received from the photo-detecting portion 52 to the sensor processing section 13.

Subsequently, the photodetector signal by the first optical sensor PS1 is captured (step ST34). Specifically, the sensor processing section 13 acquires the photodetector signal from the sensor controller 4, and stores it in its internal memory. Subsequently, a decision is made as to whether a predetermined time period has elapsed or not (step ST35) in the same manner as in the foregoing step ST32.

If a decision is made at step ST35 that the predetermined time period has elapsed, the third optical sensor PS2 is pulse driven (step ST36). More specifically, the sensor processing section 13 sends the driving instruction of the third optical sensor PS3 to the sensor controller 4. In response to the driving instruction, the sensor controller 4 generates a pulsed driving signal with an L level section of about 200 μs as illustrated in FIG. 7(A), and sends it to the light-emitting portion 51₃. Thus, the transistor Tr of the light-emitting portion 51₃ is brought into conduction, which causes a current to flow through the light-emitting diode PD to emit light. The light produced by the light-emitting diode PD passes through the prism 53₃, and irradiates the light-receiving face of the phototransistor PT of the photo-detecting portion 52₃. Thus, the phototransistor PT is brought into conduction, and the H level photodetector signal is supplied from the output terminal OUT to the sensor controller 4. The sensor controller 4 transfers the signal received from the photo-detecting portion 52 to the sensor processing section 13.

Subsequently, the photodetector signal by the third optical sensor PS3 is captured (step ST37). Specifically, the sensor processing section 13 acquires the photodetector signal from the sensor controller 4, and stores it in its internal memory. Then, the PS pattern is generated (step ST38). More specifically, the sensor processing section 13 combines the data stored in the internal memory at steps ST31, ST34 and ST37, and generates one of the 3-bit PS patterns as shown in FIG. 4. The PS pattern is referred to by the processing as shown in FIG. 5 as described above. After that, the sequence returns to the processing illustrated in FIG. 5.

Thus, in connection with the acquiring processing of the PS pattern, exclusive pulse driving of each one of the optical sensors of the optical sensor section 53 is carried out in the order of the second optical sensor PS2, first optical sensor PS1 and third optical sensor PS3 at a predetermined period of 2 ms, for example, as illustrated in FIGS. 7(A)-7(C).

The advantage of the disk detection system of the embodiment 1 in accordance with the present invention will now be described in comparison with the conventional disk detection system. In the conventional disk detection system, the first optical sensor PS1, second optical sensor PS2 and third optical sensor PS3, which are arranged in the same manner as those of the disk detection system of the embodiment 1 in accordance with the present invention, are driven simultaneously by pulse signals that fall to the L level at the same timing as illustrated in FIGS. 7(D)-7(F). Accordingly, the light-emitting diodes PD of the light-emitting portions 51₁-51₃ emit light at the same time. Consequently, when the disk D is present in the transport passage 73 as shown in FIG. 8, the light generated by the light-emitting portion 51₂ of the second optical sensor PS2 is reflected by the disk D, and is received by the photo-detecting portion 52₃ of the third optical sensor PS3, resulting in error detection. To prevent such error detection, the optical sensors each have a shielding plate (cover) to avoid interference between them.

In contrast with this, in the disk detection system of the embodiment 1 in accordance with the present invention, the exclusive pulse driving of each one of the optical sensors constituting the optical sensor section 53 is carried out in the order of the second optical sensor PS2, first optical sensor PS1 and third optical sensor PS3 as illustrated in FIGS. 7(A)-7(C). Thus, the plurality of optical sensors do not emit light at the same time. Accordingly, the light produced by the light-emitting portion of one of the optical sensors is not received by the photo-detecting portions of the other optical sensors. This obviates the need for the shielding plates, which makes it possible to solve the problem of increasing the shape of the disk drive and preventing its downsizing.

1. A disk detection system comprising:
a plurality of optical sensors disposed near a transport passage of a disk;
a controller for carrying out exclusive driving of each one of said plurality of optical sensors sequentially at a predetermined period; and
a detector for detecting an object on said transport passage according to a pattern of photodetector signals obtained by said plurality of optical sensors driven by said controller at every predetermined period.

2. The disk detection system according to claim 1, wherein
said plurality of sensors each include a light-emitting portion and a photo-detecting portion installed on one side of said transport passage, and a long prism installed at the other side of said transport passage, and wherein
said photo-detecting portion outputs the photodetector signal indicating whether or not an optical path from said light-emitting portion to said photo-detecting portion via said prism is interrupted by the object carried through said transport passage.

3. The disk detection system according to claim 2, further comprising a processing section for loading, when the object detected by said detector is a disk, the disk into a disk casing, and for ejecting, when the object is a foreign object other than the disk, the foreign object from the disk casing.
